(19) United States
(12) Patent Application Publication
(10) Pub. No.: US 2009/0155477 A1
(43) Pub. Date: Jun. 18, 2009

(54) METHODS AND APPARATUS FOR DEPOSITING SPRAY-ON FOAM INSULATION

(76) Inventors: Keith Y. Chong, Placentia, CA (US); Jeffrey S. Nicholls, Olympia, WA (US)

Correspondence Address: TUNG & ASSOCIATES / RANDY W. TUNG, ESQ., 838 W. LONG LAKE ROAD, SUITE 120, BLOOMFIELD HILLS, MI, 48302, US

(21) Appl. No.: 11/954,985

(22) Filed: Dec. 12, 2007

(51) Int. Cl. B05D 1/02; B05C 5/00

(52) U.S. Cl. 427/422; 118/612

(57) ABSTRACT

Systems and methods for forming a spray-on insulation (SOFI) coating on a structure include providing a resin material and an isocyanate material, both maintained at a temperature of between approximately 95 and 105° F., and mixing the resin material and the isocyanate material to produce a mixed material (e.g., using a spray gun having a mixing module). Using a repeated overlapping pattern having a periodicity of between approximately 5 to 10 inches, the mixed material on the structure is sprayed using a spray profile that is substantially flat and is produced at a predetermined spray distance between approximately 25-40 inches. A non-ozone-depleting blowing agent may be used.

### TECHNICAL FIELD

The embodiments described herein generally relate to foam insulation used in connection with spacecraft fuel tanks and the like, and more particularly relate to automated spray-on foam insulation (SOFI) systems.

### BACKGROUND

It is often desirable to coat various spacecraft components with an insulating coating to protect the component from very high and/or low temperatures. This is particularly the case with spacecraft fuel tanks and the like. One often-used form of coating is spray-on foam insulation (SOFI). In the SOFI process, two materials—a resin component and an isocyanate component—are mixed together and sprayed using a spray gun, resulting in an exothermal reaction that forms a tough polymeric, cellular (foam) coating on the workpiece surface.

Despite the popularity and wide use of such SOFI coatings, there is substantial room for improvement in the processes used for their formation. For example, the resulting SOFI coating often exhibits uneven thickness as well as localized bumps on its surface. For this reason, it is customary to utilize a robotic system to “shave” off a small amount of the as-deposited SOFI surface to remove any such nonuniformities. This rework increases the cost and time associated with the coating process.

Furthermore, the resin and isocyanate components are provided with a “blowing agent” that assists in movement of the materials through the gun and various hoses used in the process. As the Environmental Protection Agency (EPA) has banned certain ozone-depleting materials—many of which have traditionally been used for blowing agents—challenges remain for developing SOFI processes that utilize EPA-compliant blowing agents while at the same time maintaining or improving the quality of the resulting SOFI coating.

Accordingly, it is desirable to provide methods and systems for depositing uniform spray-on foam insulation layers on surfaces in a way that reduces rework (e.g., shaving of resulting insulation layer) and which uses desirable blowing agents in connection with the spray components (e.g., EPA-compliant blowing agents). Other desirable features and characteristics of the various embodiments will become apparent from the subsequent detailed description and the appended claims, taken in conjunction with the accompanying drawings and the foregoing technical field and background.

### BRIEF SUMMARY

Methods and apparatus are provided for producing improved spray-on foam insulation layers. In one embodiment, systems and methods for forming a spray-on insulation (SOFI) coating on a structure include providing a resin material and an isocyanate material, both maintained at a temperature of between approximately 95 and 105° F., and mixing the resin material and the isocyanate material to produce a mixed material (e.g., using a spray gun having a mixing module). Using a repeated overlapping pattern having a periodicity of between approximately 5 to 10 inches, the mixed material on the structure is sprayed using a spray profile that is substantially flat and is produced at a predetermined spray distance between approximately 25-35 inches. A non-ozone-depleting blowing agent may be used.

### BRIEF DESCRIPTION OF THE DRAWINGS

Various embodiments will hereinafter be described in conjunction with the following drawing figures, wherein like numerals denote like elements, and

FIG. 1 is a schematic overview of a spray-on foam insulation system in accordance with various embodiments;

FIG. 2 is an isometric overview of an exemplary spacecraft tank including a spray-on foam insulation layer;

FIG. 3 is an partial exploded isometric view of various components of a spray gun useful in describing various embodiments; and

FIG. 4 is an isometric overview of a spray gun in accordance with one embodiment.

### DETAILED DESCRIPTION

In general, what is described are improved methods and systems for applying polymeric spray-on foam insulation (SOFI). In this regard, the following detailed description is merely exemplary in nature and is not intended to limit the described embodiments or the application and uses of the described embodiments. Furthermore, there is no intention to be bound by any expressed or implied theory presented in the preceding technical field, background, brief summary or the following detailed description.

For simplicity and clarity of illustration, the drawing figures depict the general structure and/or manner of construction of the various embodiments. Descriptions and details of well-known features and techniques may be omitted to avoid unnecessarily obscuring other features. Elements in the drawings figures are not necessarily drawn to scale: the dimensions of some features may be exaggerated relative to other elements to assist improve understanding of the example embodiments.

Terms of enumeration such as “first,” “second,” “third,” and the like may be used for distinguishing between similar elements and not necessarily for describing a particular spatial or chronological order. These terms, so used, are interchangeable under appropriate circumstances. The embodiments described herein are, for example, capable of use in sequences other than those illustrated or otherwise described herein. Unless expressly stated otherwise, “connected” means that one element/node/feature is directly joined to (or directly communicates with) another element/node/feature, but not necessarily mechanically. Likewise, unless expressly stated otherwise, “coupled” means that one element/node/feature is directly or indirectly joined to (or directly or indirectly communicates with) another element/node/feature, but not necessarily mechanically.

The terms “comprise,” “include,” “have” and any variations thereof are used synonymously to denote non-exclusive inclusion. The terms “left,” right,” “in,” “out,” “front,” “back,” “up,” “down,” and other such directional terms are used to describe relative positions, not necessarily absolute positions in space. The term “exemplary” is used in the sense of “example,” rather than “ideal.” In the interest of conciseness, conventional techniques, structures, and principles known by those skilled in the art may not be described herein, including, for example, conventional SOFI processes, polymeric coatings, robotic manipulators, and the like.

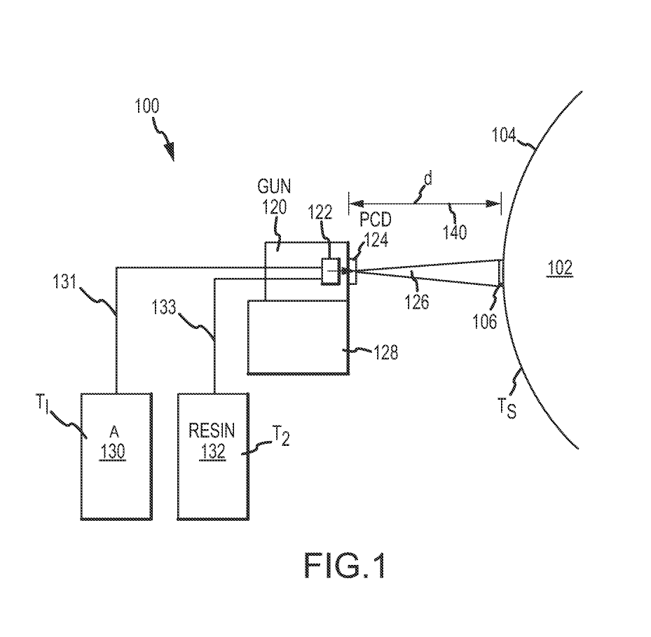

FIG. 1 is a schematic block diagram of an exemplary SOFI application system (or simply “system”) 100 in accordance with one embodiment. In general, system 100 is used to produce a spray 126 that impinges on a surface 104 of a structure 102 (e.g., a spacecraft fuel tank or the like), thereby forming a polymeric foam coating 106. System 100 includes two material sources: material 130 (source “A” or “iso source”) and material 132 (source “B”, or “resin source”). These sources are coupled via suitable hoses 131 and 133 to a spray gun 120, which produces spray 126 in accordance with a computer-controlled program.

Spray gun 120 is mechanically coupled to a manipulator or “robotic system” 128 that effects translation and/or rotation of gun 120 in three dimensions relative to surface 104. The speed of robotic system 128 will vary depending upon the application, but in one embodiment is between 4-25 mm/sec. Robotic system 128 maintains the desired distance 140 (d) from gun 120 to surface 104 of structure 102. Spray gun 120 includes a mixing module 122 for mixing material 130 with material 132, and a pattern control disc (PCD) configured to produce a particular spray pattern, as described in further detail below.

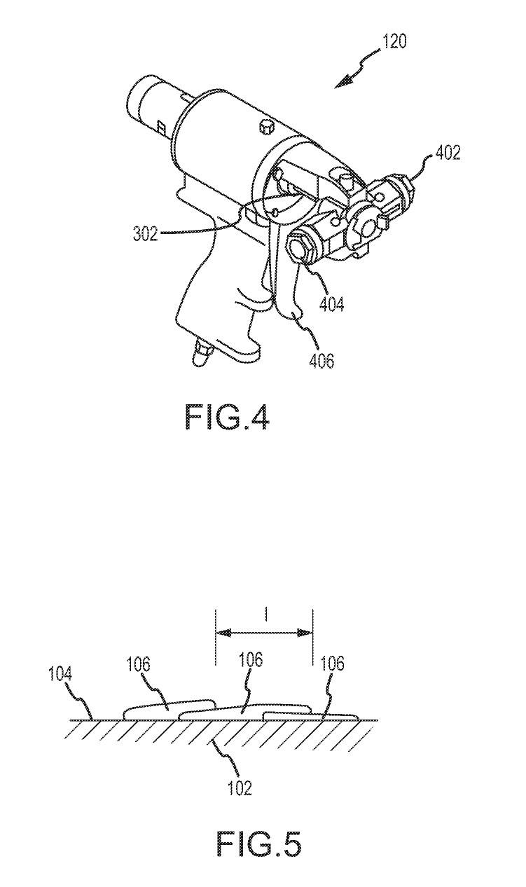

A variety of known spray guns 120 may be used in connection with the illustrated embodiment. In one embodiment, for example, as illustrated in FIG. 4, a model GX-7A spray gun manufactured by Graco Inc. of Minneapolis, Minn. is used, including a solenoid controlled switch rather than a manual trigger as illustrated. Spray gun 120 includes two inputs 402 and 404 that suitably couple to hoses 131 and 133, and also includes a trigger 406 and a valving rod 302 for controlling the spray. As further shown in the cut-away view of FIG. 3, valving rod 302 coaxially articulates with mixing module 122 and PCT 124 to produce the desired spray control.

In one embodiment, spray gun 120 is fitted with a relatively “flat” PCD 124. That is, PCD 124 preferably has a relatively flat elliptical or diamond-shape aperture—e.g., one in which its width is less than or equal to approximately one fourth of its length. In one embodiment, PCD 124 is a model no. 203 PCD manufactured by Graco/Gusmer Corp. and has a 0.050″×0.010″×0.102″ aperture (respectively indicating depth, width, length). In another, PCD 124 is diamond shape and has a 30 degree, 0.020″×0.082″ mil aperture.

One of the several factors that can affect the quality of coating 106 is the size of the mix module 122 port holes with respect to the output rate (grams per second) of the spray 126. Diameter selection for the A and B port holes in mixing module 122 is preferably performed to match the respective components hose pressure settings, thus ensuring optimum mixing of the two components in the mixing chamber of the mixing module, In accordance with one embodiment, the size of these holes and the output rate for both A and B components are adjusted such that the pressure drop at hoses 131 and 133 is within an acceptable range of 200 psi or less during the spray process. This also ensures that the optimum mixing of the two materials inside the chamber of mixing module 122 is maintained. The A and B components port holes of the mixing module are sized by carefully boring the existing holes with pre-selected drill bit sizes. In one embodiment, there are four port holes in mixing module 122—two for the A component and two for the B component. The geometry of the mixing module holes are, in one embodiment, 0.042″ for A and 0.026″ for B (barrel spray) and 0.055″ for A and 0.035″ for B (dome spray). It will be appreciated that the range of embodiments are not limited to the illustrated type of spray gun and PCD.

Material 130 is generally an isocyanate material, and source 132 is generally a resin material. As mentioned above, material 130 is also often referred to in the art as the “A” component, the “ISO” component, or “the activator.” Similarly, material 132 may be referred to as the “B” component, the “RES” component, or the “Polyol” component. These terms will be used as synonyms herein. When the two materials are mixed (i.e., in mixing module 122), they react, and the resulting exothermic reaction causes polymerization, thus forming spray-on coating 160.

A variety of SOFI materials 130 and 132 are suitable for the present invention. In various embodiments, for example, NCFI 28-134 materials manufactured by North Carolina Foam Industries (NCFI) are used. Each material 130 and 120 also includes a suitable “blowing agent” mixed in to assist in pressurizing the material for transfer within hoses 131 and 133. Because of their ozone-depleting characteristics, many traditional blowing agents have been banned for use by the Environmental Protection Agency (EPA). Thus, it desirable to utilize an EPA-approved blowing agent (e.g., HFC-245fa) in the SOFI process. The NCFI materials cited above are satisfactory in this respect.

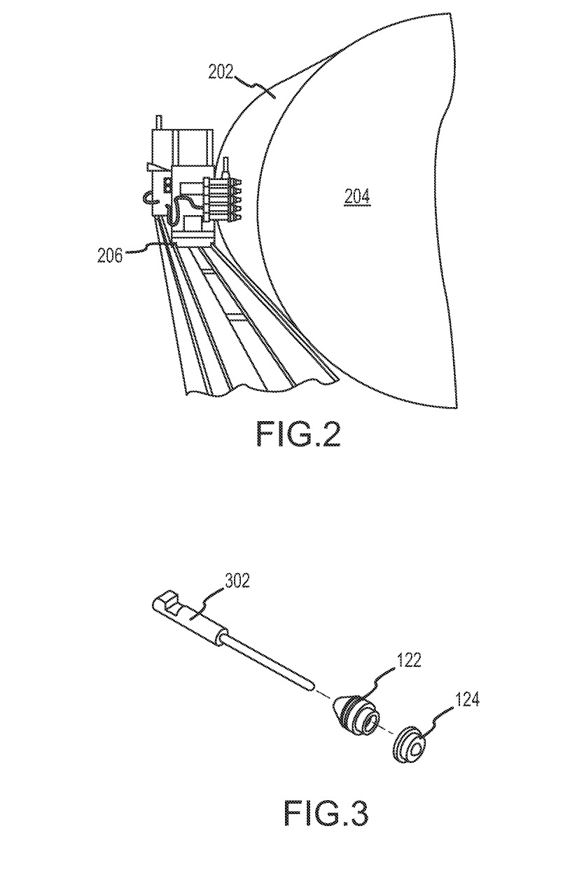

The SOFI is robotically sprayed using a robotic system 128 onto a horizontal cylindrical tank rotating in a heated and humidity-controlled booth. The tank is also heated internally during the SOFI spray. As shown in FIG. 5, which is drawn with an exaggerated scale for the purposes of illustration, the SOFI is sprayed on structure 102 in a barber-pole fashion, with overlapping layers 106 formed on surface 104 at a distance l apart. The distance l may vary depending on a number of factors, including the geometry of structure 102, the rate of rotation of the structure, etc. In a preferred embodiment, l is between about 5 and 10 inches, preferably about 5.5 inches. Such an overlap may be used, for example, in an application involving a generally cylindrical tank, as shown in FIG. 2. The tank includes two hemispherical ends (or domes) portion 204 are coated in a similar manner, except the spray gun is progressively skewed and the flow rate reduced as the dome apex is approached, to accommodate the reduction in surface speed. A robotic system 128 is used to translate the tool (in this case, a shaving apparatus) parallel to the major axis of the tank as it rotates, thereby forming the overlapping layers of SOFI.

In addition to the ambient temperature and relative humidity, the temperatures of materials A and B (T₁ and T₂, preferably about 95-105° F.), as well as the temperature Tₛ of surface 104 (preferably about 120-135° F.), are maintained at predetermined target values. Furthermore, the pressures of the materials 130 and 132 are also maintained at predetermined values. In one embodiment, the temperature of both materials 130 and 132 are maintained at approximately 100° F. (e.g., +/−5°), and the preferred pressure of A and B components is between 1000 to 1200 psi. Further in accordance with one embodiment, the surface 104 of structure 102 is maintained at a temperature of approximately 130° F. (e.g., +/−5°). In an exemplary embodiment, the ambient relative humidity is maintained at approximately 20%.

The present inventors have determined that certain selections of parameters and geometries described above lead to synergistic and/or unexpectedly favorable results with respect to the uniformity of the resulting SOFI coating. That is, coatings that are sufficiently uniform that they do not require any trimming of waves and or bumps as is common in prior art systems. In a particular embodiment, for example, a highly satisfactory coating is produced using materials 130 and 132 having the properties of NCFI 28-134 describe above and maintained at temperature of about 100° F. The materials are sprayed on using a PCD having a relatively flat geometry, wherein the spray distance 140 is substantially equal to 30″ to 40″, the temperature Tₛ of surface 104 is maintained at about 130° F., and the overlap between layers (i.e., the periodicity of adjacent layers) is reduced to between 5″ and 10″.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A method of forming a spray-on insulation (SOFI) coating on a structure, the method comprising:
providing a resin material maintained at first predetermined temperature between approximately 95 and 105° F.;
providing a isocyanate material maintained at the first predetermined temperature;
mixing the resin material and the isocyanate material to produce a mixed material;
spraying, using a repeated overlapping pattern having a periodicity of between approximately 5 to 10 inches, the mixed material on the structure using a spray profile that is substantially flat and is produced at a predetermined spray distance between approximately 25-40 inches.

2. The method of claim 1, further including maintaining the structure at a temperature of between approximately 125° F. and 135° F.

3. The method of claim 1, further including rotating the structure during the spraying step, wherein the step of using a repeated overlapping pattern includes utilizing a robotic manipulator that translates on a track parallel to a major axis of the structure.

4. The method of claim 1, wherein the step of mixing the resin material and the isocyanate material includes providing a pattern control disc having a substantially flat aperture.

5. The method of claim 4, wherein the aperture of the pattern control disc has a width that is less than or equal to approximately one fourth of its length.

6. The method of claim 5, wherein the aperture of the pattern control disc is substantially diamond-shaped.

7. The method of claim 1, wherein the resin material and the isocyanate material each include a blowing agent that is substantially non-ozone-depleting.

8. The method of claim 1, wherein the spraying step is configured to coat a generally cylindrical structure.

9. The method of claim 1, further including maintaining the first material and the second material at a first pressure of between approximately 1000 and 1200 psig.

10. A spray-on insulation (SOFI) system for coating a structure comprising:
a resin material maintained at first predetermined temperature between approximately 95 and 105° F.;
a isocyanate material maintained at the first predetermined temperature;
a spray gun including a mixing module configured to mix the resin material and the isocyanate material to produce a mixed material;
a robotic system mechanically coupled to the spray gun, the robotic system configured to move the spray gun with respect to the structure using a repeated overlapping pattern having a periodicity of between approximately 5 to 10 inches and to spray the mixed material on the structure using a spray profile that is substantially flat and is produced at a predetermined spray distance of between approximately 25-40 inches.

11. The system of claim 10, further including maintaining the structure at a temperature of between approximately 120° F. and 135° F.

12. The system of claim 10, wherein the robotic system is configured to translate along a track parallel to a major axis of the structure while the structure is rotated about the major axis.

13. The system of claim 10, wherein the step of mixing the resin material and the isocyanate material includes providing pattern control.

14. The system of claim 10, wherein the resin material and the isocyanate material each include a blowing agent that is substantially non-ozone-depleting.

15. The system of claim 10, wherein the spraying step is configured to coat a generally cylindrical structure having at least one dome located at an end thereof.

16. The system of claim 10, further including maintaining the first material and the second material at a first pressure of between approximately 1000 and 1200 psig.

17. The system of claim 10, wherein the aperture of the pattern control disc has a width that is less than or equal to approximately one fourth of its length.

18. The method of claim 19, wherein the aperture of the pattern control disc is substantially diamond-shaped.

19. A method for applying a spray-on-foam-insulation layer on a structure, the method comprising:
providing a resin material maintained at first predetermined temperature between approximately 95 and 105° F. and a first predetermined pressure between approximately 1000 and 1200 psig;
providing a isocyanate material maintained at the first predetermined temperature and first predetermined pressure, wherein the resin material and the isocyanate material incorporate a blowing agent that is non-ozone-depleting;
providing a pattern control disc having an aperture whose width is less than or equal to approximately one fourth of its length;
maintaining the structure at a structure temperature of between approximately 125° F. and 135° F.
mixing the resin material and the isocyanate material to produce a mixed material;
spraying, using a repeated overlapping pattern having a periodicity of between approximately 5 to 10 inches, the mixed material on the structure using a spray profile that is determined by the pattern control disc and is produced at a predetermined spray distance of between approximately 25-40 inches.

20. The method of claim 19, wherein the steps of providing the resin material and the isocyanate material include providing a blowing agent comprising HCFC-245fa.
